(19) United States
(12) Patent Application Publication
(10) Pub. No.: US 2008/0000507 A1
(43) Pub. Date: Jan. 3, 2008

(54) Equipment washing apparatus with flexible wall structure

(75) Inventors: David M. Snyder, Cedar Rapids, IA (US); Gregory J. Hillary, Hazel Green, WI (US)

Correspondence Address: ALLAN L HARMS, 2750 FIRST AVENUE NE, SUITE 420, CEDAR RAPIDS, IA, 52402, US

(73) Assignee: Mi-T-M Corp., Peosta, IA (US)

(21) Appl. No.: 11/478,978

(22) Filed: Jun. 30, 2006

(51) Int. Cl. B08B 3/00

(52) U.S. Cl. 134/123

(57) ABSTRACT

A washing station includes a sloped deck with sidewalls surrounding one or more sides of the deck, the sidewalls including flexible barriers. The flexible barriers are made of two rows of adjacent semi-rigid, substantially transparent panels hanging from a bar, with the semi-rigid panels of one row offset from the flexible panels of the second row such that an elongate washing wand can be threaded between panels through the barrier while the operator of the washing wand can observe the equipment or vehicle to be washed through the flexible barrier. The deck is constructed of deck modules that may be easily disconnected so that the deck modules can be moved by a forklift. Wash water run off is collected in a sloped, covered trough that contains a sump pump positioned in a filtered compartment.

### BACKGROUND OF THE INVENTION

This invention pertains to washing stations onto which machinery and vehicles can be driven to allow them to be washed with run off collected by the washing station structure.

Various washing stations have been developed which have the purpose of collecting debris and contaminants removed from a vehicle or equipment being washed. Conventional washing stations include a platform onto which the equipment is moved, usually by driving the equipment onto the platform by use of an inclined ramp. The platforms are provided with collection means to collect run off from the washing process and may include rigid upstanding walls or sides of the platform, such as seen in U.S. Pat. Nos. 6,655,396 and 6,799,591. Another version of a washing station is illustrated in U.S. Pat. No. 5,033,489 where a roof joins the upstanding rigid sidewalls. In many applications, a water recycling system is located near the washing station so that run off can be filtered, treated and cleansed sufficiently so that it can be reused to wash subsequent equipment vehicles or placed upon the washing station.

In most applications, washing is accomplished by a person spraying pressurized water onto the equipment being washed. In order to do this, the washing station must either have no sidewalls or if there are sidewalls, the sidewalls must be low enough to allow the operator to direct a spray of water over the sidewalls and onto all surfaces of the equipment to be washed. Such washing stations allow the spray operator to be hit by spray reflecting from the washed item. Because the need to clean vehicles exists in all climates and weather conditions, the operator spraying the equipment may be subjected to reflected spray in cold conditions that will make the spraying job very unpleasant. Furthermore, a substantial need exists for the washing station to be portable so that it can be moved close to a job site so that the equipment to be washed will not distribute debris and contaminants over a wider area than necessary as it is moved to the washing station.

A need exists for a portable washing station which can be easily moved without using a crane, and further a strong need exists for a washing station which allows the spray operator to be protected from overspray and reflected spray while washing the equipment located on the washing station.

### BRIEF SUMMARY OF THE INVENTION

This invention provides a washing station, also commonly called a washing pad, on which vehicles, construction machinery and other large equipment may be placed for washing with the washing station containing the debris and effluent from the washing process. The washing station includes a deck assembled from a series of modular sections joined to create a sloped platform to cause the deck to drain to one side. Each modular section includes fork openings so that the unassembled deck sections can be lifted and moved by a forklift. The top plate of each modular section overhangs its support frame by a small amount at the lower end of the modular member so that run off exiting the deck can drop into a collection trough. The collection trough is composed of end-to-end disconnectable trough sections located adjacent the lower side of the deck such that the top plates of the modular sections slightly overhang the open top of the collection trough assembly. The bottom of the trough assembly slopes downward to one end of the trough assembly from which liquid may be pumped. Removable cover members rest on the open top of the collection trough assembly and each includes a tab that is received in a slot in the modular deck section adjacent the cover. A filter enclosure is located in the trough at its collection end to strain particulates from the wash water run off before the filtered run off is pumped or suctioned from within the filter enclosure to be transferred to a water recycling system associated with the washing station. An easily replaceable sump pump is located within the filter enclosure in the trough assembly to draw filtered run off to the water recycling system.

The deck may also be assembled of two series of modular sections, each making a separate deck section with each deck section sloped downward toward the other deck section in order to drain run off into a trough assembly which is placed between the deck sections. This arrangement allows construction of a doublewide washing station by using standard modular sections of the deck.

The deck is surrounded on three sides by sidewall assemblies that include sidewall frame members, rigid lower wall panels mounted to the lower portions of the frame members and a flexible barrier above the rigid wall panels which includes flexible narrow curtain panels that hang from an upper rail of the sidewall frame members. The curtain panels are arranged in two closely spaced offset rows with spaces between adjacent curtain panels so that the flexible curtain of the sidewalls will form a non-rigid barrier but also one that will permit a spraying wand to be threaded between adjacent flexible panels by deflecting adjacent panels slightly. The flexible panels are preferably transparent or translucent so that an operator of a spraying wand can see through the flexible panel barrier to aim the washing spray onto the desired part of the equipment to be washed.

Ramp members are supported at their lower ends on the ground surface and at their upper ends upon a rail or wall edge by a hook structure thereby allowing the ramp members to be adjusted to easily change the spacing between them, in order to accommodate differing wheel separations of vehicles which may be driven up the ramp members and onto the deck.

Accordingly, the objects of this invention are:

(a) to provide an improved washing station with sidewalls which provide a barrier to shield the spray operator while permitting the operator to see the equipment to be washed and to pass the spraying wand through spaces between adjacent curtain panels in the sidewalls;

(b) to provide a washing station having a deck constructed of modular components that does not require a crane to relocate the deck;

(c) to provide a washing station with ramp members which can be easily varied in spacing to accommodate vehicles of varying wheel spacing;

(d) to provide a washing station which can be easily expanded to accommodate very large machinery to be washed;

(e) to provide a washing station which allows collection of filtered run off by a sump pump that can be easily replaced when necessary;

(f) to provide a washing station with flexible panel sidewalls through which the vehicle to be washed can be observed.

These and other objects of the invention will become apparent from examination of the description and claims that follow.

### BRIEF DESCRIPTION OF THE SEVERAL VIEWS OF THE DRAWINGS

FIG. 1 is a front right perspective of a washing station according to the invention.

FIG. 2 is an exploded view, in perspective, of the washing station of FIG. 1, with parts thereof omitted to ease in understanding of interrelationships of the structural components.

FIG. 3 is a greatly enlarged view in perspective of a segment of the curtain wall, with the lower ends of curtain panels cut away.

FIG. 4 is an enlarged view in perspective of a trough section of the run off collection trough of the invention.

FIG. 5 is an enlarged view in perspective of a deck module of the invention.

FIG. 6 is a front elevation of the deck module of FIG. 5.

FIG. 7 is an enlarged side plan view of the deck module of FIG. 5.

FIG. 8 is an enlarged view in perspective of a trough cover of the invention.

FIG. 9 is an enlarged front elevation of a ramp member of the invention.

### DETAILED DESCRIPTION OF THE INVENTION

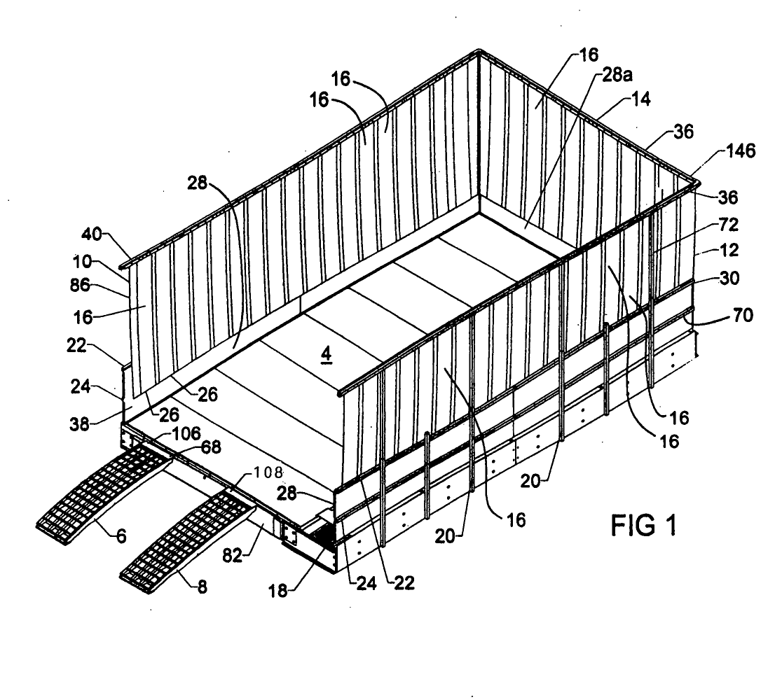

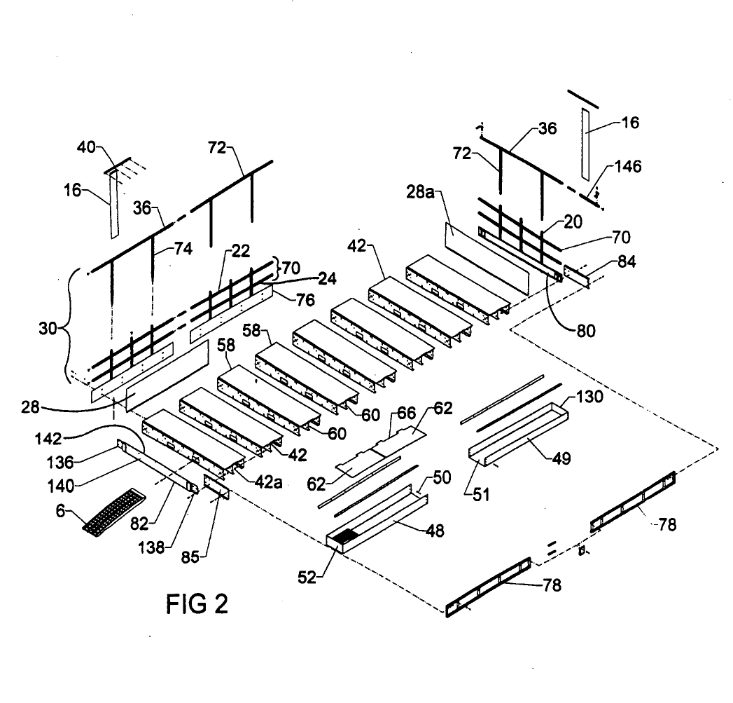

Referring to FIGS. 1 and 2, the washing station invention 2 is seen to include a platform or deck 4, ramp members 6, 8, sidewalls 10, 12, end wall 14, and run off collection trough 18. A vehicle or other machine to be washed or decontaminated may be moved up ramp members 6, 8 onto deck 4 to rest thereon during the washing or decontamination flowage thereof. Because deck 4 is sloped toward trough 18, run off from washing or decontamination will move by gravity toward trough 18 where it will be collected. Run off reaching trough 18 will be filtered and may be drawn from trough 18 to a water treatment and recycling system not shown in the drawings but exemplified by a Mi-T-M® WCL series water treatment system manufactured by the Mi-T-M Corporation of Peosta, Iowa. (See http://www.mitm.com).

Application of washing fluid, which may be a detergent solution, heated or cool water, or another satisfactory solvent, may be accomplished by spraying a high pressure spray onto the item to be washed from a pressure washer wand which may be inserted through curtain wall 86 in gaps between overlapping curtain panels 16 of sidewalls 10, 12 and end wall 14.

Sidewalls 10, 12 and end wall 14 include an open framework 30 comprising a lower frame assembly 70 and an upper frame assembly 72. Lower frame assembly 70 comprises upright members 20 and lateral members 22, 24. Upper frame assembly 72 comprises top rail 36 supported on standards 74. Standards 74 may be supported on selected upright members 20. Each of lateral frame assemblies 70 and upper frame assemblies 72 may be constructed in eight foot lengths so that open frameworks 30 may be disassembled into components of length not exceeding eight feet. Rigid panels 28 are also eight feet in length and are mounted to lower frame assemblies 70.

Curtain walls 86 are located above rigid panels 28 and comprise plural curtain panels 16 which are suspended from top rails 36 of open frameworks 30. The lower end 26 of each curtain panel 16 lies against an inside face 38 of the rigid panel 28. Curtain panels 16 are non-rigid, being flexible or semi rigid clear polyvinyl chloride strips or other clear flexible or semi-rigid polymer strips.

From reference to FIG. 2, it may be understood that washing station 2 is modular in construction. Deck 4 comprises multiple deck modules 42 which are selectively joined in series. Deck modules are preferably eight feet in length and two or four feet in width so that deck 4 may be assembled in increments of two or four feet. Each deck module 42 includes transverse fork openings 44 so that a forklift or fork equipped end loader or skid loader can load and move the deck modules 42.

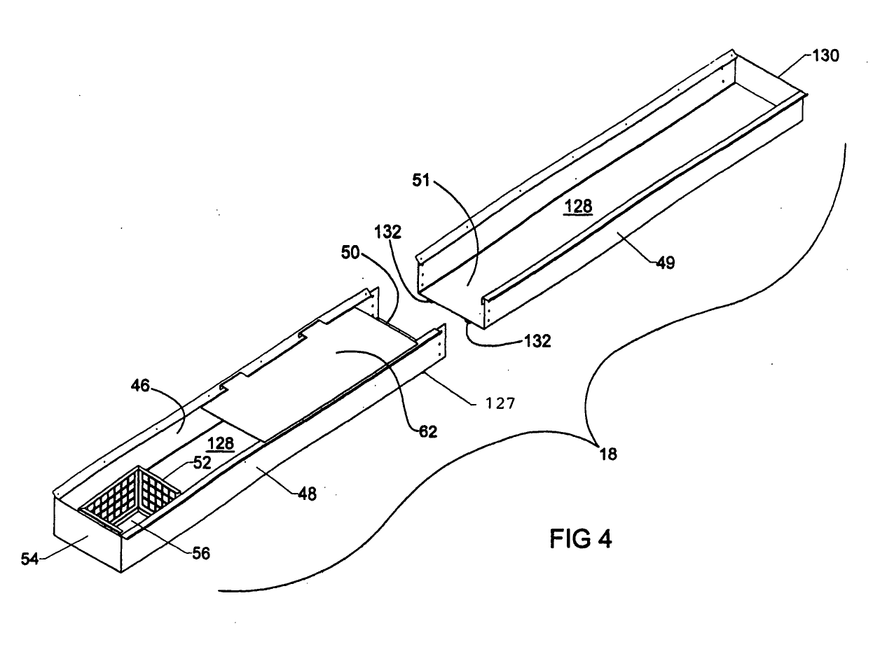

Trough 18 comprises trough sections 48, 49 which may be constructed in eight foot lengths. First trough section 48 longitudinally joins second trough section 49 to form trough 18. Trough sections 48 and 49 are joined at open ends 50, 51 respectively thereof. As best seen in FIG. 4, first trough section 48 includes a cross rail 127 mounted thereunder to raise open end 50 thereof above removal end 54 thereof. Second trough section 49 is provided with cross rail 127 that decline in height from distal end 130 to open end 51 thereof. The assembled trough 18 therefore is sloped toward removal end 54.

A multi-walled filter element 52 may be received in removal end 54 of trough 18 to create a compartment 56 for placement of a submersible sump pump (not illustrated) to be used to draw filtered run off from trough 18 as it accumulates. Filter element 22 serves to separate large particulates from the run off wash water.

The inclusion of cross rail 127 and tapered longitudinal rails 132 causes floor 128 of trough 18 to slope downwardly from distal end 130 to removal end 54 to facilitate drainage of run off toward filter element 52 and sump pump compartment 56. Rails 132 are taller at distal end 130 of second trough section 49 than at open end 51 thereof.

Covers 62 rest upon the open top 46 of trough sections 48, 49 but permit run off from deck 4 to enter the open top 46 of trough 18 through openings in the open top 46 left uncovered by covers 62 at tab edges 66 thereof.

Curtain walls 86 comprise curtain panels 16 which are retained to top rails 36 by attachment strips 40. Curtain panels 16 are preferably substantially transparent or translucent semi-rigid or flexible polymer strips about eight inches in width. Curtain panels 16 are preferably constructed of clear polyvinyl chloride of 0.08 inch thickness. Curtain panels 16 are preferably about five feet to about six feet in length, so long as a curtain wall 86 and rigid panel 28 serve to make a barrier to spray reflecting from the equipment being washed.

Deck side panels 76, which may be 8 feet in length, are mountable to the higher ends 58 of deck modules 42 and enclose them. Trough side panels 78 assist in retaining trough sections 48 in abutment with lower ends 60 of deck modules 42 when selected deck modules 42 have been assembled into deck 4. Closed deck end panel 80 may be assembled to lateral frame assembly 70 when used as part of end wall 14. Extension panel 84 extends across distal end 130 of trough 18. Rail extension 146 joins top rail 36 of end wall 14 with the top rail 36 of sidewall 12 and provides a support for flexible panels 16 to hang over an opening between end wall panel 28a and sidewall 12.

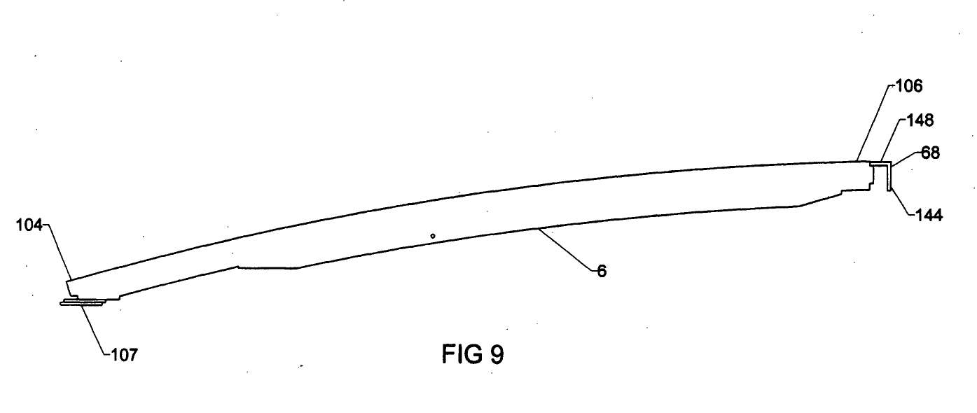

Entry end panel 82 is elongate having ends 136 and 138 which mount to the first deck module 42a. Entry end panel 82 includes a projected central region 140, which is spaced away from first deck module 42a when ends 136 and 138 are mounted to the first deck module 42a. Referring additionally to FIG. 9, brackets 68 of ramps 6, 8 may hook over top edge 142 of entry end panel 82 so that first ends 106, 108 of ramps 6, 8 may slide along central region 140 in order to permit easy adjustment of the separation of ramps 6, 8. Trough panel 85 extends across removal end 54 of trough 18 and joins trough side panel 78.

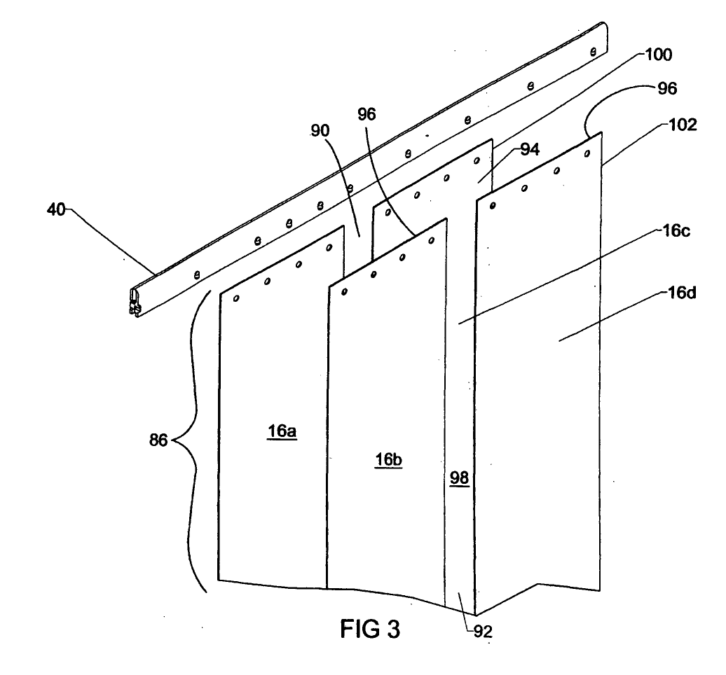

Referring now to FIG. 3, a segment of curtain wall 86 is illustrated, showing arrangement of curtain panels 16 suspended from attachment strip 40. Curtain panels 16 are arranged in spaced apart, side by side fashion. For illustration, four curtain panels 16a, 16b, 16c and 16d are seen in FIG. 3. It is seen that curtain panels 16 are arranged in two closely spaced offset rows 100, 102 arranged such that outer panel row gaps 90 are left between outer panels 16a, 16c and inner panel row gaps 92 exist between inner panels 16b and 16d. Therefore a washing wand being held by a spray operator may be threaded between flexible outer panels 16a and 16c through outer panel gaps 90 and between inner panels 16b, 16d through inner panel gap 92. Except for a small opening created as the curtain panels 16 are deflected by penetration of the thin elongate washing wand, the curtain wall 86 created by the arrangement of overlapping adjacent curtain panels 16 remains inviolate and prevents sprayed fluids reflecting from the equipment being washed from contacting the washing wand operator. If a second spray operator is washing from the opposite side or from the end of the washing station 2, overspray passing the equipment being washed will not strike an other spray operator.

It is to be understood that curtain panels 16 are arranged in outer rows 100 and inner rows 102 such that portions of the first face 94 of a curtain panel 16 in the outer row 100 will be in close proximity or in touching abutment to the opposing second face 96 of two adjacent curtain panels 16 of the inner row 102. That is, in the illustration of FIG. 3, first face 94 of curtain panel 16c abuts both a portion of second face 96 of curtain panel 16b and a portion of second face 96 of curtain panel 16d while a central segment 98 of first face 94 of curtain panel 16c is exposed to inner curtain gap 92 of inner row 102 of curtain panels 16. Preferably the width of gaps 90 and 92 is approximately equal to fifty percent of the width of curtain panels 16 so that, in reference to FIG. 3, approximately twenty-five percent of the width of first face 94 of curtain panel 16c closely opposes or abuts second face 96 of curtain panel 16b and approximately twenty-five percent of the width of first face 94 of curtain panel 16c closely opposes or abuts second face 96 of curtain panel 16d.

In the case of end wall 14, flex panels 16 may be longer in the area below rail extension 146 so that a flexible barrier is made across the space between rigid panel 28 and of end wall 14 and side wall 12.

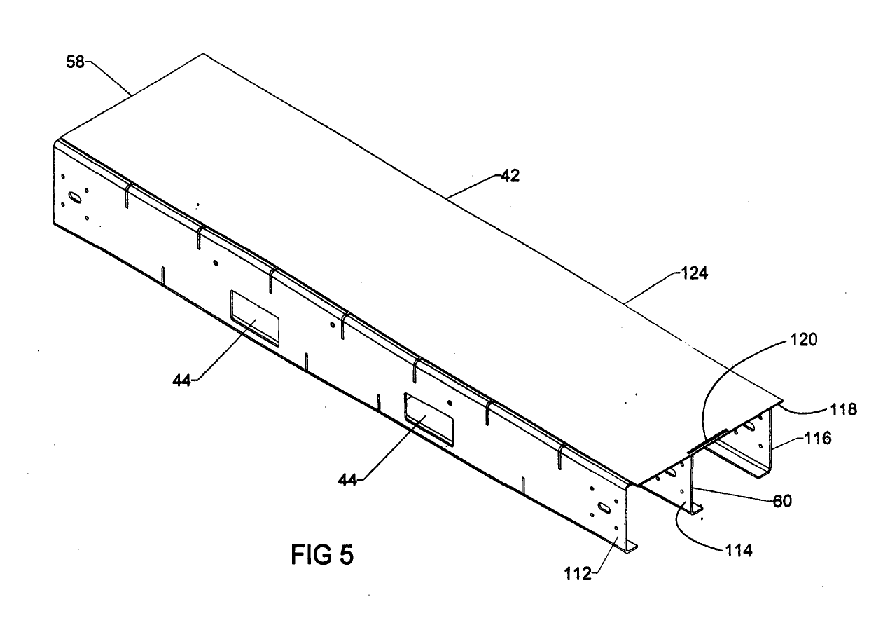

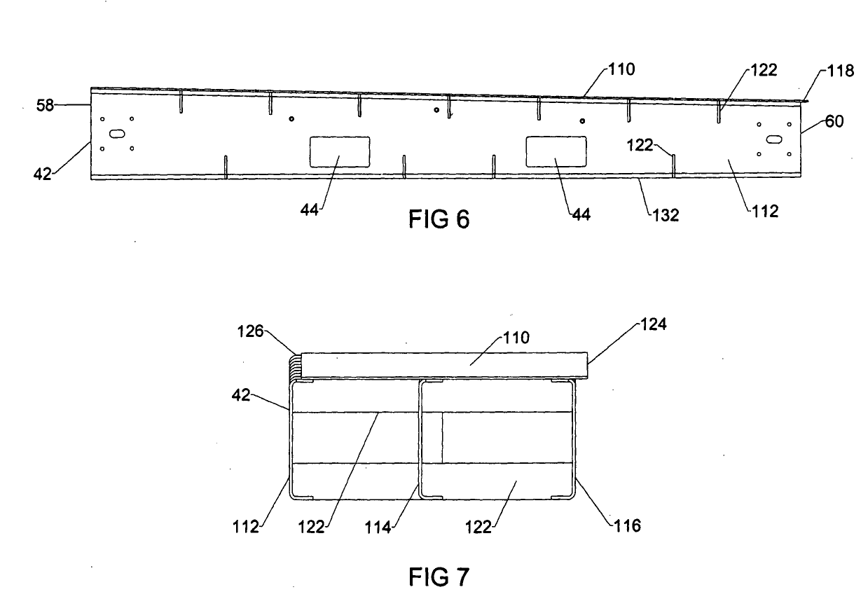

Referring now additionally to FIGS. 5-7, one deck module 42 is illustrated. Deck module 42 comprises a top plate 110 supported by longitudinal beams 112, 114, and 116. Each of beams 112, 114, 116 is of C-shaped construction. Beams 112, 114 and 116 are tapered in height from higher end 58 of deck module 42 to its lower end 60 such that top plate 110 is sloped downward so run off will drain toward lower end 60 and fall off overhang 118 of lower end 60 into trough 18 (see FIGS. 1 and 2).

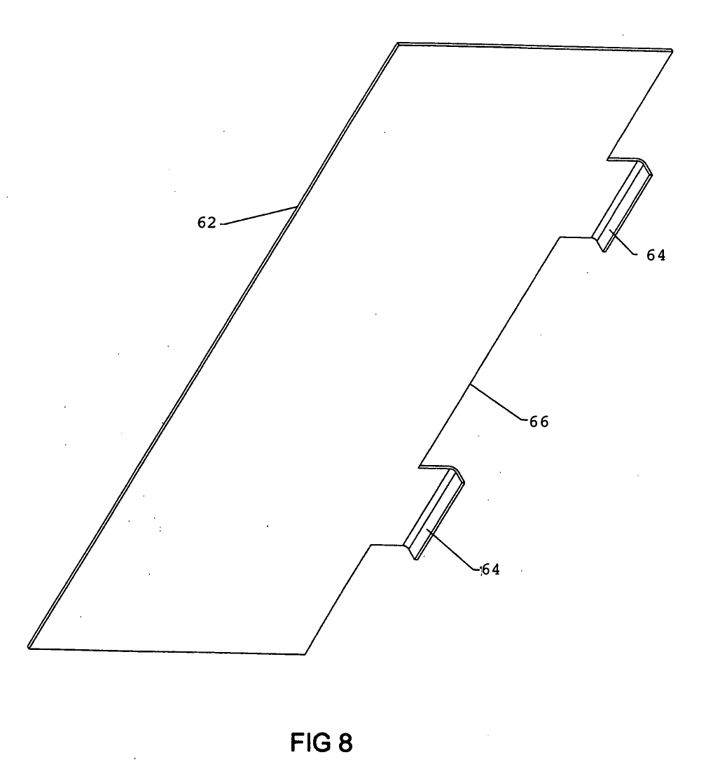

An elongate slot 120 is formed in top plate 110 to receive a tab 64 of a cover 62 (see FIG. 8). The cooperation between slots 120 of deck modules 42 and tabs 64 of covers 62 provides proper location of covers 62 over trough sections 48, 49 leaving a gap over open top 46 of trough 18 where covers 62 do not extend.

Deck module 42 is provided with fork openings 44 to allow deck modules 42 to be easily transported by a forklift or other lifting fork equipped machine.

Deck module 42 includes transverse support ribs 122 which are used to strengthen the deck module 42. Support ribs 122 pass through each of beams 112, 114, 116 and are welded thereto to strengthen the deck module 42. One set of support ribs 122 is attached to beams 112, 114, 116 immediately below top plate 110 and a second set of support ribs 122 is located at the bottom 132 of deck module 42.

First edge 124 of top plate 110 of each deck module 42 cantilevers to overlie the exposed upper end 126 of first support beam 112 of the next adjacent deck module 42 such that each top plate 110 is supported in part by the first beam 112 of the neighboring deck module 42.

FIG. 8 provides an enlarged perspective of a trough cover 62 showing the downwardly directed tabs 64 thereof which extend from first edge 66 such that a gap remains between first edge 66 and overhang 118 of each deck module 42 of deck 4 when tabs 64 are located in slots 120 of top plates 110 of deck modules 42.

FIG. 9 shows a ramp member 6, ramp member 8 being identical thereto. Ramp member 6 includes first end 106 from which bracket 68 extends such that depending leg 144 depends from extending leg 148 downward to be captured behind top edge 142 of central region 140 of entry end panel 82 (see FIG. 2). Ground supported end 104 of ramp 6 may be provided with slide pads 107 thereon.

By making all components of the wash station 2 modular, it can be understood that the wash station can be enlarged in increments and could be doubled in width with trough 18 centered between deck assemblies with lower ends 60 of the deck modules 42 of a first deck assembly opposing lower ends 60 of the second deck assembly. With such an arrangement, the run off would drain to the center of the deck and into the trough 18 for removal of the used water and its treatment and recycling.

The foregoing description of the invention has been presented for purposes of illustration and description and is not intended to be exhaustive or to limit the invention to the precise form disclosed. Modifications and variations of the embodiments are possible in light of the above disclosure or such may be acquired through practice of the invention. The embodiments illustrated were chosen in order to explain the principles of the invention and its practical application to enable one skilled in the art to utilize the invention in various embodiments and with various modifications as are suited to the particular use contemplated. It is intended that the scope of the invention be defined by the claims appended hereto, and by their equivalents.

1. Vehicle washing apparatus comprising
a deck member supported above grade,
ramp members removeably attached to the deck member,
the deck member being sloped to facilitate drainage of fluids therefrom,
at least a first collection member disposed to collect fluids draining from the deck member,
wall elements upstanding around at least a part of a periphery of the deck member,
the wall elements comprising a plurality of non-rigid panels,
each non-rigid panel overlapping another non-rigid panel,
whereby adjacent non-rigid panels may be deflected to allow passage of a wash wand therebetween.

2. The vehicle washing apparatus of claim 1 wherein
each non-rigid panel comprises a first face and an opposing second face,
each non-rigid panel having at least a portion of the first face thereof in opposition to at least a portion of the second face of the non-rigid panel adjacent thereto.

3. The vehicle washing apparatus of claim 1 wherein
the non-rigid panels are arranged in at least two closely spaced rows,
the non-rigid panels of each of the at least two closely spaced rows having spaces therebetween,
each space between adjacent non-rigid panels of a first of the at least two closely spaced rows opposing a first face of a non-rigid panel of a second of the at least two closely spaced rows.

4. The vehicle washing apparatus of claim 1 wherein the non-rigid panels are transparent.

5. The vehicle washing apparatus of claim 1 wherein the non-rigid panels are constructed of clear polyvinyl chloride.

6. The vehicle washing apparatus of claim 1 wherein the wall elements are disposed along three sides of the deck member.

7. The vehicle washing apparatus of claim 1 wherein the non-rigid panels are approximately twelve inches wide and approximately eight feet long.

8. The vehicle washing apparatus of claim 1 wherein
the deck comprises a series of deck modules selectively joined together,
each deck module having a first end taller than an opposing second end thereof.

9. The vehicle washing apparatus of claim 8 wherein
each deck module comprises spaced apart fork openings therethrough whereby the deck module may be lifted and transported by a fork equipped machine.

10. The vehicle washing apparatus of claim 8 wherein
a top plate of each deck module extending from a shorter end of the deck module.

11. The vehicle washing apparatus of claim 10 wherein the top plate of each deck module includes a slot.

12. The vehicle washing apparatus of claim 11 wherein
the at least a first collection member is abutted to each deck module against the lower end thereof,
plural cover members rest atop the collection member,
each cover member including at least one tab receivable in one of the slots of the deck modules.

13. The vehicle washing apparatus of claim 1 wherein
each ramp member includes a first end with a bracket depending therefrom,
the deck member having a plate at an entry end thereof,
the bracket of each ramp member hooked over a top edge of the plate at the entry end of the deck member,
whereby each ramp member may be moved toward or away from the other ramp member without disconnection from the deck member.

14. Wash pad apparatus comprising
a platform on which equipment may be supported,
a wash fluid spray apparatus including an elongate spray wand operable by a user,
a wall disposed adjacent at least one edge of the platform,
the wall comprising a plurality of upright semi-rigid elongate segments,
whereby the spray wand may be inserted between adjacent upright semi-rigid elongate segments to facilitate spraying liquids on equipment located on the platform, the flexible segments shielding a user of the spray wand from sprayed fluid.

15. The wash pad apparatus of claim 14 wherein
the semi-rigid segments are suspended from upper ends thereof,
each semi-rigid segment aligned to overlap at least a portion of at least one other of the semi-rigid segments.

16. The wash pad apparatus of claim 14 wherein
the platform is sloped to effectuate escape of fluids therefrom,
a collection trough disposed adjacent a first edge of the platform,
the collection trough disposed below the first edge to collect fluids escaping from the platform,
covers resting upon the collection trough,
the platform having an overhanging edge at a lower side thereof,
the overhanging edge overlying the collection trough.

17. The wash pad apparatus of claim 14 wherein
a pair of spaced apart ramp members is disposed adjacent a second edge of the platform to permit a vehicle to access the platform from a lower grade,
the ramp members including a bracket depending downwardly from a platform connecting end thereof,
the second edge of the platform having a receiving element therealong,
the receiving element generally aligned with a top surface of the platform,
the bracket of each ramp member hooked over the receiving element,
whereby spacing between the ramp members may be modified by sliding the platform connecting ends of the ramp members along the receiving element.

18. The wash pad assembly of claim 17 wherein
the receiving element is an upper edge of an upstanding plate fixed to the second edge of the platform.

19. A wash pad assembly on which vehicles may be positioned, comprising
a plurality of deck modules selectively joined in side-by-side abutment to form a generally planar, sloped deck,
each deck module sloped upwardly from a first side to an opposing second side,
a collection trough selectively retained to the first sides of the deck module,
each deck module having a top plate,
the top plate of each deck module extending over a part of the collection trough.

20. The wash pad assembly of claim 19 wherein
the collection trough comprises a plurality of covers disposed thereon, each cover having one or more tabs extending therefrom,
the deck of each deck module comprising a slot into which a one of the one or more tabs is receivable.

21. The wash pad assembly of claim 19 wherein
each deck module comprises fork openings,
whereby forks of a lifting apparatus may be received in the fork openings such that the deck modules may be lifted by the lifting apparatus.

22. A wash pad assembly on which vehicles may be positioned, comprising
a deck member supported above grade,
a collection trough disposed in abutment to a lower edge of the deck member,
the collection trough comprising a removal end and a bottom,
the bottom sloped downward to the removal end,
whereby liquids in the collection trough drain toward the removal end thereof.

23. (canceled)

24. The wash pad assembly of claim 22 wherein
the bottom of the trough member is supported on longitudinal rails,
the rails being of non-uniform height,
the rails tallest at a distal end of the trough.

25. The vehicle washing apparatus of claim 1 wherein the wall elements are suspended from upper ends thereof.
